(19) United States
(12) Patent Application Publication
(10) Pub. No.: US 2013/0288495 A1
(43) Pub. Date: Oct. 31, 2013

(54) CIRCUIT BOARD MODULE WITH PROTECTING COVER

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: BIAO ZENG, Wuhan (CN); XIANG ZHANG, Wuhan (CN); TAI-BAO WU, Wuhan (CN); YUAN-TING GUO, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/743,955

(22) Filed: Jan. 17, 2013

(30) Foreign Application Priority Data
Apr. 27, 2012 (CN) 201210126748.7

(51) Int. Cl. H01R 13/443

(52) U.S. Cl. CPC H01R 13/443
USPC 439/148

(57) ABSTRACT

A circuit board module includes a first circuit board and a protecting cover. A high speed interface is located on the first circuit board, for receiving a second circuit board. The high speed interface defines two latch slots. The protecting cover includes a cover body and a knob located on the cover body. The knob includes two resilient pieces and two latch tabs. The two latch tabs are located on the two resilient pieces, respectively. When the second circuit board is not connected to the high speed interface, the cover body covers the first high speed interface. Each of the two latch tabs is engaged in each of the two latch slots, to prevent the cover body from moving away the high speed interface. The two resilient pieces are resiliently deformable to disengage each of the two latch tabs from each of the latch slots.

### BACKGROUND

1. Technical Field

The present disclosure relates to circuit board modules, and particularly to a circuit board module with a protecting cover.

2. Description of Related Art

A single conventional central processing unit (CPU) in a computer may not satisfy the requirements of increased mass processing. Therefore, it may be necessary to increase the number of the CPUs. Two CPUs may be used and are usually connected to each other via a high speed interface. In order to reduce cost and satisfy the demand of mass processing, a high speed interface is designed. When the high speed interface is left unused, a plurality of golden fingers on the interface may be damaged without protection.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of a circuit board module, a protecting cover being not shown.

FIG. 2 is an exploded view of a first circuit board of FIG. 1 and the protecting cover.

FIG. 3 is an isometric view of the protecting cover of FIG. 3.

FIG. 4 is an assembled view of the first circuit board and the protecting cover of FIG. 1.

FIG. 5 is an enlarged view of the circled portion V of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

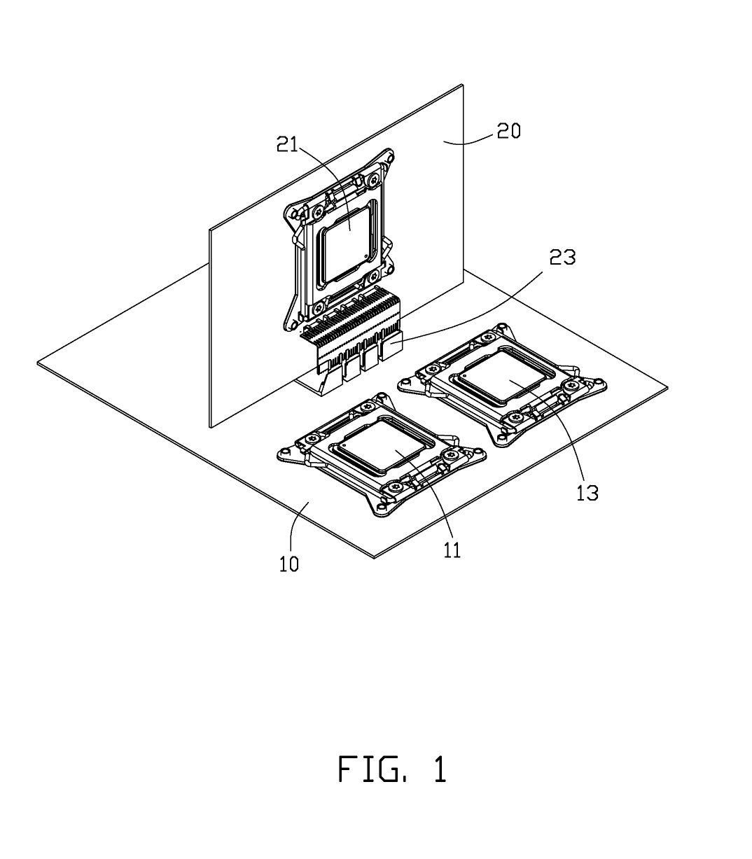

FIG. 1 illustrates a circuit board module 80 in accordance with one embodiment. The circuit board module 80 includes a first circuit board 10 and a second circuit board 20.

A first processor unit 11 and a second processor unit 13 are located on the first circuit board 10. A high speed interface 15 is located on the first circuit board 10 and positioned on one side of the first processor unit 11 and the second processor unit 13. The high speed interface 15 includes a plurality of golden fingers 153 configured to be electrically connected with the second circuit board 20. The side plate 151 defines two latch slots 1511. A positioning post 155 protrudes from one end of the high speed interface 15.

A third processor unit 21 and the connector 23 are located on the second circuit board 20. The connector 23 electrically connects to the high speed interface 15.

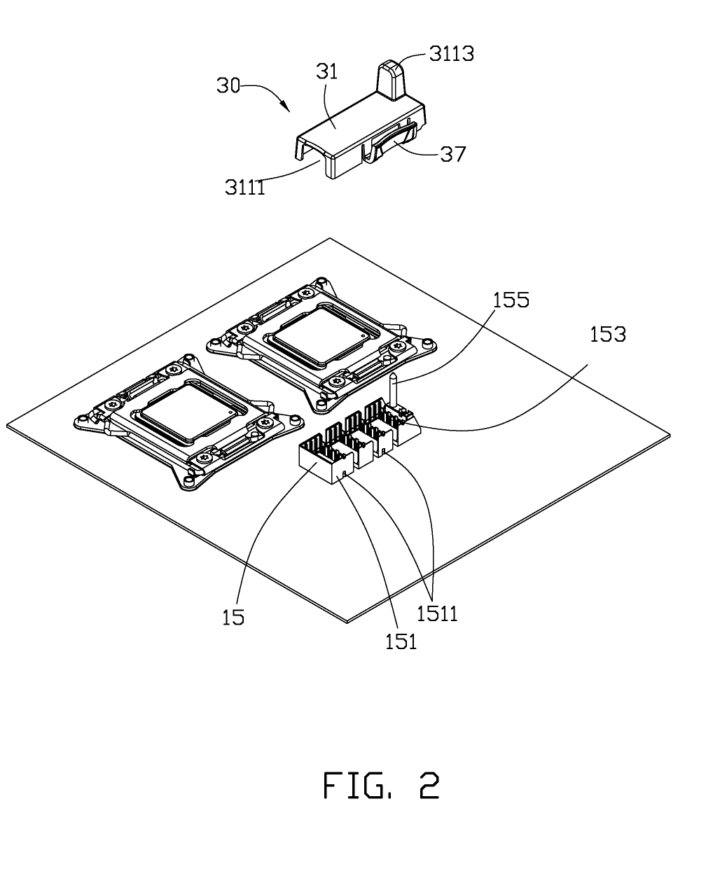

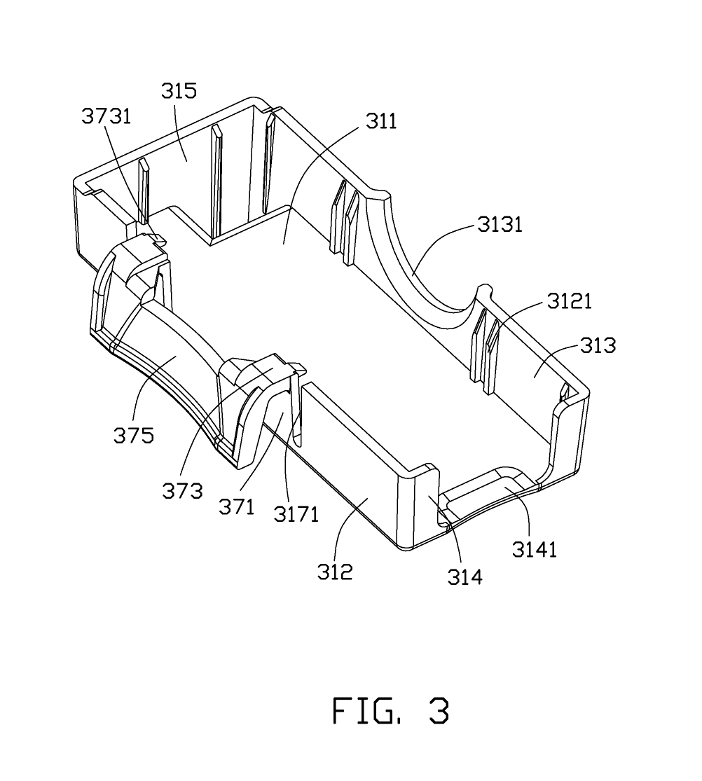

Referring to FIGS. 2-3, the circuit board module 80 further includes a protecting cover 30 for covering the high speed interface 15. The protecting cover 30 includes a cover body 31 and a knob 37 located on the cover body 31. The cover body 31 includes a top wall 311, a front wall 312, and a rear wall 313, a first sidewall 314, and a second sidewall 315. The top wall 311 is substantially parallel to the first circuit board 10. A receiving space 3111 is defined among the top wall 311, a front wall 312, a rear wall 313, a first sidewall 314, and the second sidewall 315, for receiving the high speed interface 15. The front wall 312 and the rear wall 313 extend from two opposite edges of the top wall 311. The front wall 312 is substantially parallel to the rear wall 313. The first sidewall 314 and the second sidewall 315 extend from another two opposite edges of the top wall 311. The first sidewall 314 is substantially parallel to the second sidewall 315. The top wall 311 is substantially rectangular. A sleeve 3113 is located on a corner of the top wall 311 and can receive the positioning post 155. A plurality of strips 3121 protrude from an inner side of each of the front wall 312, the rear wall 313, the first sidewall 314, and the second sidewall 315, to engage with the high speed interface 15. The rear wall 313 defines a cutout 3131 for conveniently uninstalling the protecting cover 30. The cutout 3131 may be arc-shaped, for example. The first sidewall 314 defines an opening 3141 for positioning the protecting cover 30.

A knob 37 includes two resilient pieces 371, two converting pieces 373, and an operating piece 375. The two resilient pieces 371 extend from the front wall 312. A slit 3171 is defined between each of the two resilient pieces 371 and the front wall 312. Each of the two converting pieces 373 extend outwards from one side of each of the two resilient pieces 371. Two latch tabs 3731 extend inwards from another side of the two resilient pieces 371. The operating piece 375 connects to the two converting pieces 373 and is opposite to the two resilient pieces 371.

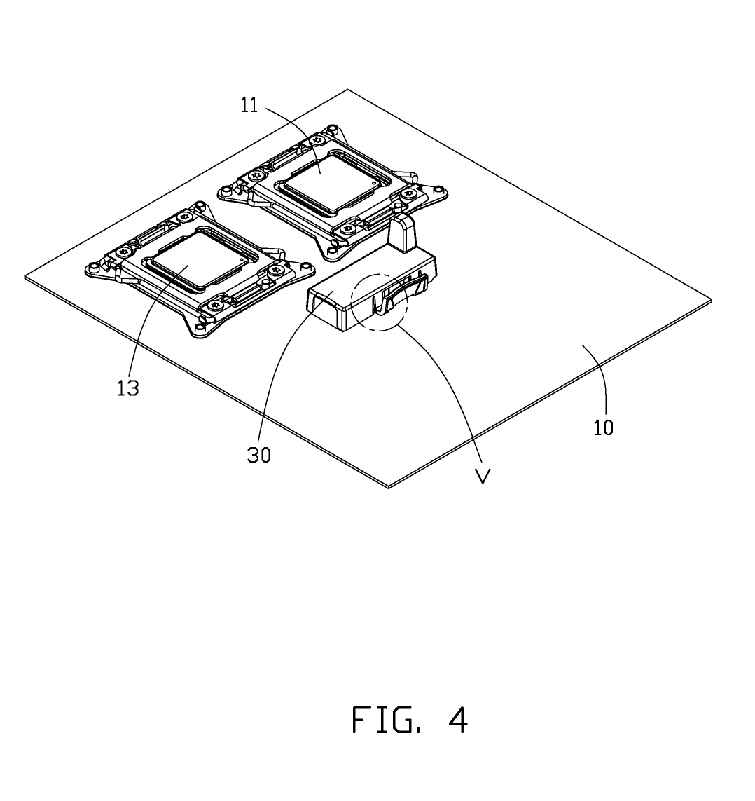

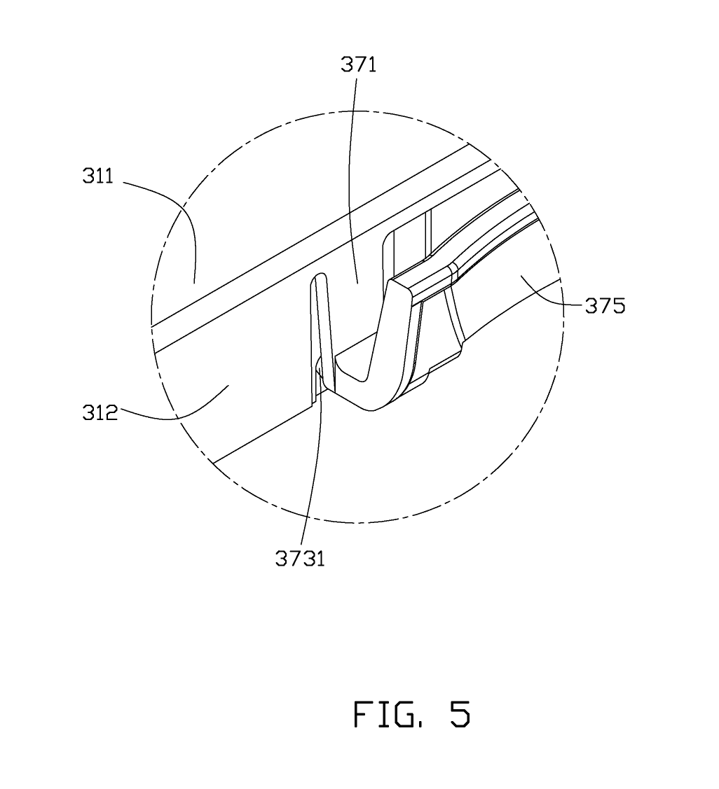

Referring to FIGS. 4 and 5, in assembly, the operating piece 375 of the protecting cover 30 is drawn outwards, and the two resilient pieces 371 are resiliently deformed to move the two latch tabs 3731 outside of the cover body 31. The high speed interface 15 can be received in the receiving space of the protecting cover 30, and the positioning post 155 is received in the sleeve 3113 of the protecting cover 30. The plurality of strips 321 are engaged with the side plate 151, for preventing the protecting cover 30 from being disengaged from the high speed interface 15. Until each of the two latch tabs 3731 is aligned with each of the two latch slots 1511 of the high speed interface 15, the operating piece 375 is released. The two resilient pieces 371 resiliently rebound to move the two latch tabs 3731 to engage with the two latch slots 1511. The protecting cover 30 is thereby secured to the first circuit board 10, to protect the plurality of the golden fingers 153 of the high speed interface 15.

When detaching the protecting cover 30, the operating piece 375 is pulled, and the two resilient pieces 371 are resiliently deformed to disengage the two latch tabs 3731 from the two latch slots 1511. Therefore, the protecting cover 30 can be lifted away from the first circuit board 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A circuit board module comprising:
a first circuit board, a high speed interface located on the first circuit board, two latch slots defined in the high speed interface; and
a protecting cover, the protecting cover comprising a cover body and a knob located on the cover body, the knob comprising two resilient pieces and two latch tabs, each of the two latch tabs being located on each of the two resilient pieces,
wherein the cover body covers the high speed interface on the first circuit board, each of the two latch tabs is engaged in each of the two latch slots each of the two latch tabs is configure to prevent the cover body from moving along a direction substantially perpendicular to the first circuit board; the cover body is released from the high speed interface by the two resilient pieces being resiliently deformed to disengage from each of the latch slots.

2. The circuit board module of claim 1, wherein the cover body comprises a front wall, the two resilient pieces are located on the front wall, and each of the two resilient pieces and the front wall defines a slit.

3. The circuit board module of claim 2, wherein the cover body further comprises a rear wall opposite to the front wall, and the front wall is substantially parallel with the real wall.

4. The circuit board module of claim 3, wherein the rear wall defines an arc-shaped cutout.

5. The circuit board module of claim 3, wherein a plurality of strips are located on the rear wall and the front wall, and the plurality of strips are configured to engage with the high speed interface.

6. The circuit board module of claim 1, wherein the cover body comprises a top wall, and the top wall is substantially parallel to the first circuit board.

7. The circuit board module of claim 6, wherein a positioning post is located on the high speed interface, a sleeve is located on the top wall, and the positioning post is received in the sleeve.

8. The circuit board module of claim 1, wherein the knob comprises two converting pieces, the two converting pieces and the two latch tabs are located on opposite sides of the two resilient pieces.

9. The circuit board module of claim 8, wherein the knob further comprises an operating piece, and the operating piece is opposite to the two resilient pieces and connects to the two converting pieces.

10. A protecting cover comprising:
a cover body configured to cover a high speed interface of a circuit board; and
a knob on the cover body, the knob comprising two resilient pieces and two latch tabs, each of the two latch tabs being on each of the two resilient pieces and configured to engage with the high speed interface to secure the cover body to the high speed interface; the two resilient pieces are resiliently deformable to disengage the two latch tabs from the high speed interface.

11. The protecting cover of claim 10, wherein the cover body comprises a front wall, the two resilient pieces are located on the front wall, and each of the two resilient pieces and the front wall defines a slit.

12. The protecting cover of claim 11, wherein the cover body further comprises a rear wall opposite to the front wall, and the front wall is substantially parallel with the real wall.

13. The protecting cover of claim 12, wherein the rear wall defines a cutout, and the cutout is arc-shaped.

14. The protecting cover of claim 12, wherein a plurality of strips are located on each of the rear wall and the front wall, and the plurality of strips are configured to engage with the high speed interface.

15. The protecting cover of claim 10, wherein the cover body comprises a top wall, and the top wall is configured to cover the high speed interface.

16. The protecting cover of claim 15, wherein a sleeve is located on the top wall, and the sleeve is configured to receive a positioning post of the high speed interface.

17. The protecting cover of claim 10, wherein the knob comprises two converting pieces, the two converting pieces and the two latch tabs are located on two opposite sides of the two resilient pieces.

18. The protecting cover of claim 17, wherein the knob further comprises an operating piece, and the operating piece is opposite to the two resilient pieces and connects to the two converting pieces.
